(19) United States
(12) Patent Application Publication
(10) Pub. No.: US 2011/0213477 A1
(43) Pub. Date: Sep. 1, 2011

(54) METHOD FOR CONTROLLING IN PARTICULAR LIGHTING TECHNOLOGY BY AUDIO SIGNAL AND A DEVICE FOR PERFORMING THIS METHOD

(76) Inventor: Jaroslav NUSL, Praha (CZ)

(21) Appl. No.: 13/126,539

(22) PCT Filed: Oct. 29, 2009
(86) PCT No.: PCT/CZ2009/000130

§ 371 Date: Apr. 28, 2011

(30) Foreign Application Priority Data
Oct. 29, 2008 (CZ) PV 2008-676

(51) Int. Cl. A63J 17/00; G06F 17/00

(52) U.S. Cl. 700/94

(57) ABSTRACT

A method for controlling in particular lighting technology by audio signal and a device for performing this method especially relate to the control of in particular lighting technology by audio signal, where the analogue signal of the sound recording is converted into a digital value and the obtained data is converted from the time domain to the frequency domain. The obtained values are also assigned to the individual attributes with pre-set data, and an actual scene is generated for each attribute at any moment in time. The resulting scene is generated from the actual scenes so that the values that do not influence mutually the same parameters of the same technology are only bundled into the resulting scene and the resulting scene is then intended directly for the control of the connected technology. The invention also relates to a device to perform this method.

### BACKGROUND AND SUMMARY

The invention relates to a method of controlling in particular lighting technology by audio signal, wherein the analogue signal of the sound recording is converted into a digital value; and the invention also relates to a device to perform this method.

The market offers a variety of lighting technology and panels as well as programs for controlling it. The DMX512 (Digital Multiplex) protocol, designed by the USITT (United States Institute for Theatre Technology) in 1986, is used prevalently for remote centralized control. The whole stage lighting system can be then controlled from a single panel by trained personnel, or using a special prepared programme. Intelligent, centrally controlled technology can be used for architectural lighting, exhibitions, presentations, advertising, theatres, films, and in particular to create an atmosphere during music performances. In this latter case, there are efforts to control the lighting technology in a way corresponding with the specific music performance. It is operated by trained personnel, or a simple control system is used with a microphone, often built in every piece of equipment separately. In some cases the technology is controlled by a pre-set programme, which does not correspond with the music performance at all. Separate control using only a microphone is based only on a simple principle that does not by far use the possibilities of intelligent lighting technology. Most often, the control is based on the detection of peaks in the audio signal, where this detection can be possibly divided into different frequency bands, or is based on distinguishing BPM (Beats Per Minute). These acquired values are then used to actuate or switch sequences prepared in advance. There are also many visualization programmes, but they only provide software-based visualization on a display device, without the possibility to control any hardware.

The deficiencies mentioned above are, to a large extent, eliminated by a method of controlling in particular lighting-technology by audio signal, wherein the analogue signal of the sound recording is converted into a digital value, as specified in an aspect of this invention. Its essence is that the data is converted from the time domain to the frequency domain. The acquired data is then used to prepare an arithmetic mean of the sound volume of low, medium and high frequencies in a short and long time span and an arithmetic mean of the overall sound volume in a short and long time span. The obtained values are also assigned to the individual attributes with pre-set data. This data is influenced by the output value of the attribute in the ratio controller, and then an actual scene is generated for each moment in time at the output of each ratio controller; the resulting scene is created from all these scenes so that the values that do not influence mutually the same parameters of the same equipment are bundled into the resulting scene. If the actual generated actual scenes influence each other, they shall be used based on priority. This obtained resulting scene is intended directly for controlling the connected technology.

The pre-set data comprises, advantageously, information on which technology and which parameter are influenced by the specific attribute; the data is static or is created by a sequence of scenes in time.

The invention also relates to a device to perform this method. The device comprises of a sound signal input, to which an A/D converter is connected. A signal converter from the time domain to the frequency domain is connected to the A/D converter, and an averaging device is connected to the converter to average the values from the frequency domain; an attribute associated with an information element using a ratio controller is attached to its output, where a switch is attached to all information elements to allow an immediate attachment of the information element at the output.

A complementing unit is installed advantageously between the switch and the individual ratio controllers.

This solution allows to use the data obtained from the sound to control the technology.

The goal of this invention is to allow the creative control of lighting and other technology directly by music, thus using its possibilities better. Some of the advantages offered by this new control method compared to the previous method of control by an illuminator or a program are as follows.

It is possible to synchronize individually each connected device with the music, regardless of their quantity. Another advantage is an immediate response to any unpredictable changes in music. It is possible to harmonize the lighting technology even with new, previously unknown performances. The solution allows a better utilization of the technology. Unlike control by specialized personnel, this equipment never gets tired and allows non-stop operation. It is not necessary to interfere with the control, as the music contains all of the necessary information. The system can be also used where lighting technology is already installed.

### LIST OF DRAWINGS

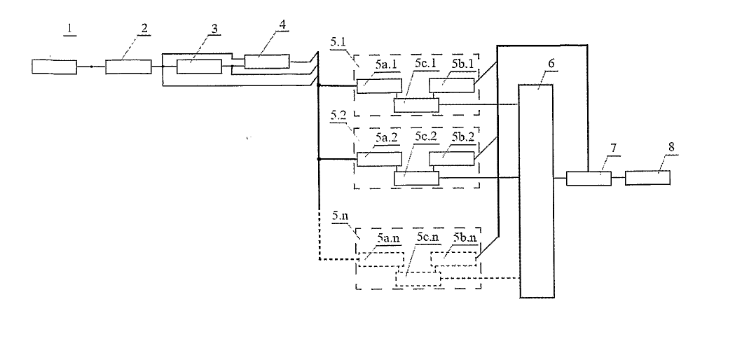

An embodiment of this equipment for controlling in particular lighting technology by audio signal as described in this invention will be described in detail on a specific example using the attached drawing, where FIG. 1 shows the connection diagram.

### DETAILED DESCRIPTION

The audio signal in frequency domain 3 and in time domain 2 is brought to the input of each attribute 5a.1 to 5a.n. Each of the attributes 5a has attached data 5b set by the user. This data 5b comprises information on which equipment and which parameter shall be influenced by the given attribute 5a. This can be static data or the so-called scene, or a sequence of scenes in time-chase. The data 5b is influenced by the output value of the attribute 5a in the ratio controller 5c as follows: (a) in a static scene, the size of the input values is given linearly in the same proportion as the output value of the attribute 5a. In case the marginal value of the output of the attribute 5a is 100%, the output of the ratio controller 5c shows exactly the same data 5b as defined by the user. In case the marginal value is 0%, the output of the ratio controller 5c is zero. (b) in case of a chase, the output of the attribute 5a influences linearly the speed of this chase in the range of 0 to 100%. If the output of the attribute 5a is zero, the output of the ratio controller 5c is also zero. The output from all ratio controllers 5c.1 to 5c.n is brought to the complementing unit 6, where a resulting scene is generated for each moment in time. The data from the ratio controllers 5c, if zero, is ignored by the complementing unit 6. The other data is used to generate the resulting scene so that the values that do not influence mutually the same parameters of the same equipment are only bundled into the resulting scene. If, however, some data at the output of the ratio controllers 5c influences the same parameters of the same equipment, the decision on the use of the data from the given ratio controller 5c shall be made by priority. Unless specified otherwise; the priority of the ratio controllers 5c.1 to 5c.n is given linearly, where the first connected ratio controller 5c.1 has the lowest priority and the last ratio controller 5c.n the highest priority. This obtained resulting scene at the output of the complementing unit 6 is intended directly for controlling the connected technology.

The connection can be extended by an averaging device 4, to which the audio signal in frequency domain 3 and in time domain 2 is also brought. This averaging device 4 performs the most frequently used calculations and sends them to all assigned attributes 5a.1 to 5a.n. This reduces the number of redundant calculations that would be performed in each attribute 5a1 to 5a.n separately. These can be values such as arithmetic mean of the sound volume of low, medium and high frequencies in a short and long time span and arithmetic mean of the overall sound volume also in a short and long time span.

Another extension is the connection of a switch 7, which can send one from each data block 5b.1 to 5b.n directly to the output 8. This makes it possible to visually check the behaviour of the lighting technology as set by the user for the given attribute 5a.

The attribute 5a is any connection or algorithm that generates other values from the values obtained in point 2, 3 or 4; in a way, these other values express what happens in the music. These can be exact as well as non-exact procedures. Examples are attributes 5a that induce times in the music or express the sound volume in different frequency bands. Another example is an indication showing whether the sound volume is declining or growing. Generating this data is then obvious. All values obtained from the averaging device 4 can be also used as an attribute 5a. The attribute 5a indicating volume intensity in low frequencies only uses this value from the averaging device 4, where the intensity is multiplied at the output by a constant, if applicable, with a defined minimum value under which the output shall be permanently zero and with a defined maximum value which, when exceeded, shall always yield the maximum (100%) at the output.

The connection diagram of the embodiment shows the output 1 of the audio signal, to which an A/D converter 2 as well as a converter 3 of the signal from the time domain to the frequency domain are connected; the latter converter can be based for example on Fast Fourier Transformation (FFT). The averaging device 4 averages the values from the frequency domain. The data in the frequency domain is divided into three consecutive areas and its arithmetic mean is calculated for each area at any moment in time. The arithmetic mean for all values in the frequency domain is also calculated. All these four values constitute the output from the averaging device 4. Another 8 values are generated so that the first four obtained values are averaged as an arithmetic mean with a small number of values obtained for previous time moments (steps) and averaged as an arithmetic mean with a large number of values obtained for previous time moments (steps).

The information element 5b contains data that carries information on which equipment and which parameter shall be influenced by the given attribute 5a. In the ratio controller 5c, the output data A is converted into output data C in the ratio given by the input value B. In the complementing unit 6, one data framework (of the same format) is generated from the data obtained as outputs from all ratio controllers so that the data from the ratio controllers 5c, if zero, is ignored by the complementing unit 6.

The switch 7 makes it possible to connect any one input to the output. As a default, the output from the complementing unit 6 is attached to the output of the switch 7. If the user needs to check the data associated to any attribute 5a, he can send it directly to the output 8 using the switch 7. This obtained data is already sent directly to the connected technology.

The method for controlling in particular lighting technology by audio signal and a device to perform this method can be used especially where lighting and other technology has to be synchronized with music. Operation can be fully independent or in cooperation with control performed by operating personnel.

1. A method for controlling in particular lighting technology by audio signal in which the analogue signal of the sound recording is converted into a digital value, characterized by the fact that the obtained data is converted from the time domain to the frequency domain, the obtained values are provided to individual attributes with pre-set data, after which an actual scene is generated for each attribute at any moment in time, while the resulting scene is generated from the actual scenes so that the values that do not influence mutually the same parameters of the same technology are merely bundled into the resulting scene and this resulting scene is intended director for controlling the connected technology.

2. The method as in claim 1, wherein the acquired data is used to prepare at least an arithmetic mean of the sound volume of low, medium and high frequencies in a short and long time span and an arithmetic mean of the overall sound volume in a short and long time span.

3. The method as in claim 1, wherein the pre-set data comprises information on which technology and which parameter are influenced by the specific attribute; the data is static data or a sequence of scenes in time.

4. The method as in claim 1, wherein the data assigned to the individual attributes is influenced by the output value of the attribute in the ratio controller.

5. The method as in claim 4, wherein in a static scene the size of the output values is given linearly in the same ratio as the output value of the attribute, while in case the marginal value of the output of the attribute is 100%, the output of the ratio controller shows exactly the same data as defined by the user, and if the marginal value is 0%, the output of the ratio controller is zero; if this concerns a sequence of scenes in time, the output of the attribute influences linearly the speed of this sequence in the range of 0 to 100%, where if the output of the attribute is zero, the output of the ratio controller is also zero.

6. The method as in claim 4, wherein if the data from the ratio controllers is zero, it is ignored.

7. The method as in claim 4, wherein if any of the data at the output of the ratio controllers influences the same parameters of the same technology, the decision on the use of the data from the given ratio controller shall be made by priority.

8. The method as in claim 7, wherein the priority of the ratio controllers is given linearly, where the first connected ratio controller has the lowest priority and the last ratio controller the highest priority.

9. A device to perform the method as in claim 1, comprising the input of the audio signal to which an A/D converter is connected, wherein a signal converter of the signal from the time domain to the frequency domain is connected to the A/D converter, and an attribute connected to an information element by way of a ratio controller is connected to its output, where a switch is attached to all information elements to (5b.n) to allow an immediate attachment of the information element at the output.

10. The device as in claim 9, wherein an averaging device is connected to the converter of the signal from the time domain to the frequency domain and to the A/D converter in order to average the values from the frequency and time domains, where the attributes to are connected to its output.

11. The device as in claim 10, wherein a complementing unit is installed between the switch and the individual ratio controllers to.
